(19) United States
(12) Patent Application Publication
(10) Pub. No.: US 2014/0006638 A1
(43) Pub. Date: Jan. 2, 2014

(54) METHOD AND A NETWORK NODE, FOR USE IN A DATA CENTER, FOR ROUTING AN IPV4 PACKET OVER AN IPV6 NETWORK

(71) Applicants: Alan Kavanagh, Montreal (CA); Suresh Krishnan, Montreal (CA)

(72) Inventors: Alan Kavanagh, Montreal (CA); Suresh Krishnan, Montreal (CA)

(21) Appl. No.: 13/676,718

(22) Filed: Nov. 14, 2012

Related U.S. Application Data
(60) Provisional application No. 61/666,279, filed on Jun. 29, 2012.

(51) Int. Cl. G06F 15/16

(52) U.S. Cl. 709/236

(57) ABSTRACT

A method, for use in a data center having tenants, of routing an IPv4 packet over an IPv6 network as an IPv6 packet includes: receiving the IPv4 packet from a first virtual machine associated with a first tenant and addressed to a second virtual machine associated with a second tenant; generating the header of the IPv6 packet to include an IPv6 address determined by applying a reversible transformation to one of: a combination of the IPv4 source address and an identifier of the first tenant, and a combination of the IPv4 destination address and an identifier of the second tenant; generating the payload of the IPv6 packet based on the payload of the received IPv4 packet; generating the IPv6 packet by assembling the generated payload with the generated header of the IPv6 packet; and transmitting the generated IPv6 packet over the IPv6 network to the second virtual machine.

### PRIORITY STATEMENT UNDER 35 U.S.C. S.119(E) & 37 C.F.R. S.1.78

This non-provisional patent application claims priority based upon the prior U.S. provisional patent application entitled “METHOD AND A NETWORK NODE, FOR USE IN A DATA CENTER, FOR ROUTING AN IPV4 PACKET OVER AN IPV6 NETWORK”, application No. 61/666,279, filed Jun. 29, 2012, in the names of Alan KAVANAGH and Suresh KRISHNAN, the contents of which are expressly incorporated herein by reference.

### TECHNICAL FIELD

The present invention generally relates to telecommunication networks, and more particularly to a method and a network node, in a data center, for routing an Internet Protocol version 4 (IPv4) packet over an Internet Protocol version 6 (IPv6) network.

### BACKGROUND

An IPv4 address is composed of 32 bits, which yields an address space of 4294967296 (2³²) addresses. With the constant increase in popularity of Internet connected devices, available IPv4 addresses are becoming scarce. The problem of the IPv4 address exhaustion has stimulated the development of the IPv6 protocol, which provides a 128 bit address space. The IPv6 protocol provides significant improvements over the IPv4 protocol in terms of address capacity, security, network management, mobility and quality of service. The IPv6 protocol has been deployed since 2006. However, the IPv4 protocol is still widely used, thus the coexistence of the IPv4 network and IPv6 network will still occur for a while.

The basic structure of an IPv4 packet is well-known in the art. As shown in FIG. 1, the IPv4 packet 100 comprises a header 102 and a payload 104. The header 102 includes an IPv4 source address 106 and an IPv4 destination address 108, each of the IPv4 addresses being composed of 32 bits. The header 102 further comprises a plurality of other fields 110, which are well-known in the art, such as the version field, the Time To Live (TTL) field, etc.

In a same manner, an IPv6 packet is also composed of a header and a payload. The header comprises an IPv6 source address and an IPv6 destination address, each of the IPv6 addresses being composed of 128 bits. The header also includes other fields, which are well-known in the art.

An IPv4 application cannot be run over an IPv6 network. For instance, if the infrastructure of a data center used for cloud computing forms an IPv6 network, then the network nodes and servers within the data center will communicate with each other using IPv6. If the virtual machines (VMs), hosted by the servers in the data centers, still support applications which run using the IPv4 protocol, the VM-based applications will have difficulty communicating without some form of protocol translation.

As such, there is a need for a solution to enable and support the existing IPv4 applications to run over the IPv6 network.

Several solutions have been proposed to solve the above problem. For example, one solution uses an address translation mechanism, such as a Network Address Translation (NAT). Under the address translation mechanism, when an IPv4 node wishes to reach an IPv6 node, the addresses in an IPv4 packet header are translated into IPv6 addresses and an IPv6 packet is created. The IPv6 packet is transmitted over the IPv6 network. NAT provides a one-to-one translation of IP addresses. However, NAT requires state information to be maintained for each stateful communication session between nodes. Thus, it adds overhead to the communication session. Also, it is common to hide an entire IP address space, usually consisting of private IP addresses, behind a single IP address in a public address space. In this case, a one-to-many NAT is used, but this translation must alter higher level information such as TCP/UDP ports in outgoing communications and must maintain a table so that returning packets can be correctly translated back. NAT has other drawbacks such as decreasing the quality of the Internet connectivity and breaking the IP end-to-end connectivity model.

Another solution is to use a Dual Stack Lite (DS-Lite). The DS-Lite works by assigning temporary IPv4 addresses to dual-stacked nodes using IPv6. The DS-Lite node or server acts as a gateway between the different networks to allow IPv4 traffic to travel over the IPv6 network by using an IPv4 over IPv6 tunnel. Thus, DS-Lite-based systems require tunneling, which yields an overhead to the communication session. Tunneling also requires state information to be maintained for each stateful communication session between nodes. Therefore, DS-Lite is complex to implement and adds additional processing loads in the network.

Therefore, there is a need to provide an improved method for routing IPv4 packets over an IPv6 network.

### SUMMARY

It is an object of the present invention to obviate or mitigate at least one disadvantage of the prior art.

According to a first aspect of the invention, there is provided a method, for use in a data center having tenants, of routing an Internet Protocol version 4 (IPv4) packet, having a payload and a header that includes IPv4 source and destination addresses, over an Internet Protocol version 6 (IPv6) network as an IPv6 packet having a payload and a header. The method comprises: receiving the IPv4 packet from a first virtual machine associated with a first tenant, the IPv4 packet addressed to a second virtual machine associated with a second tenant; generating the header of the IPv6 packet to include an IPv6 address determined by applying a reversible transformation to one of: a combination of the IPv4 source address and an identifier of the first tenant, and a combination of the IPv4 destination address and an identifier of the second tenant; generating the payload of the IPv6 packet based on the payload of the received IPv4 packet; generating the IPv6 packet by assembling the generated payload of the IPv6 packet with the generated header of the IPv6 packet; and transmitting the generated IPv6 packet over the IPv6 network to the second virtual machine.

According to a second aspect of the invention, there is provided a method, for use in a data center having tenants, of delivering an Internet Protocol version 4 (IPv4) packet to a virtual machine, the IPv4 packet being received as an IPv6 packet having a payload and a header which includes an IPv6 destination address. The method comprises: determining the virtual machine associated with a tenant based on the IPv6 destination address; generating a header of the IPv4 packet to include an IPv4 destination address determined based on the IPv6 destination address; generating a payload of the IPv4 packet based on the payload of the IPv6 packet; generating the IPv4 packet by assembling the generated header with the generated payload; and routing the generated IPv4 packet to the determined virtual machine associated with the tenant.

According to a third aspect of the invention, there is provided a network node, in a data center having tenants, for routing an Internet Protocol version 4 (IPv4) packet, having a payload and a header that includes IPv4 source and destination addresses, over an Internet Protocol version 6 (IPv6) network as an IPv6 packet having a payload and a header. The network node comprises: a communication interface for receiving the IPv4 packet from a first virtual machine associated with a first tenant, the IPv4 packet addressed to a second virtual machine associated with a second tenant; and a processor operationally connected to the communication interface and configured to: generate the header of the IPv6 packet to include an IPv6 address determined by applying a reversible transformation to one of: a combination of the IPv4 source address and an identifier of the first tenant, and a combination of the IPv4 destination address and an identifier of the second tenant; generate the payload of the IPv6 packet based on the payload of the received IPv4 packet; and generate the IPv6 packet by assembling the generated payload of the IPv6 packet with the generated header of the IPv6 packet; wherein the communication interface further transmits the generated IPv6 packet over the IPv6 network to the second virtual machine.

According to a fourth aspect of the invention, there is provided a network node, in a data center having tenants, for delivering an Internet Protocol version 4 (IPv4) packet to a virtual machine, the IPv4 packet being received as an IPv6 packet having a payload and a header which includes an IPv6 destination address. The network node comprises: a processor configured to: determine the virtual machine associated with a tenant based on the IPv6 destination address; generate a header of the IPv4 packet to include an IPv4 destination address determined based on the IPv6 destination address; generate a payload of the IPv4 packet based on the payload of the IPv6 packet; and generate the IPv4 packet by assembling the generated header with the generated payload; and a communication interface in connection with the processor for routing the generated IPv4 packet to the virtual machine associated with the tenant.

Those skilled in the art will recognize additional features and advantages upon reading the following detailed description, and upon viewing the accompanying drawings.

### BRIEF DESCRIPTION OF THE DRAWINGS

Like reference numerals designate corresponding similar parts. The features of the various illustrated embodiments can be combined unless they explicitly exclude each other. Exemplary embodiments are depicted in the drawings and are detailed in the description which follows.

FIG. 1 illustrates a structure of an IPv4 packet, as known in the art;

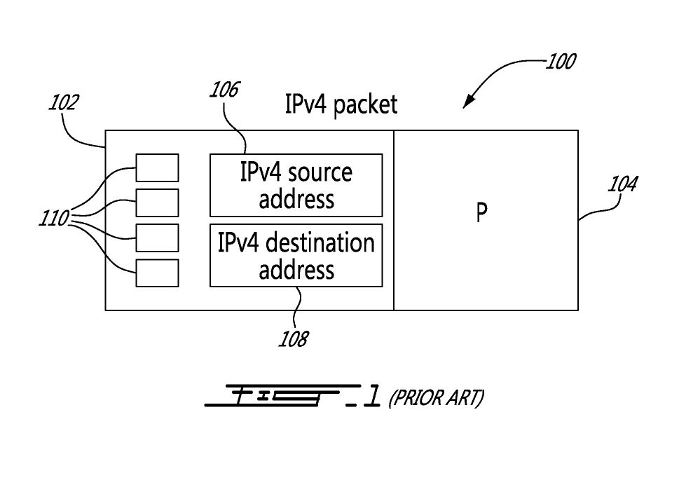

FIG. 2 illustrates a data center connected to the Internet through a plurality of switches and a router;

FIG. 3 illustrates a method, for use in the data center of FIG. 2, for routing an IPv4 packet over an IPv6 network as an IPv6 packet, according to an embodiment of the present invention;

FIG. 4 illustrates an IPv6 packet, according to an embodiment of the present invention;

FIG. 5 illustrates a method, for use in the data center of FIG. 2, for delivering an IPv4 packet to a virtual machine, the IPv4 packet being received as an IPv6 packet, according to an embodiment of the present invention;

FIG. 6 is a schematic diagram of a network node for carrying out either the method of FIG. 3 or the method of FIG. 5; and

FIG. 7 illustrates a flow diagram of an implementation example of a communication between two virtual machines over an IPv6 network, according to an embodiment of the present invention.

### DETAILED DESCRIPTION

Embodiments of the present invention will be described in the context of a data center for cloud computing, for example. The data center can host a large number of virtual machines which are offered to customers, also referred to as tenants, as part of a computing and storage service. The customers typically pay as they use the service of the virtual machines.

A virtual machine (VM) is a software implementation of a computing environment in which an operating system and/or program can be installed and run. The VM typically emulates a physical computing environment. A single server can instantiate a plurality of VMs. The VMs are created within a virtualization layer or platform, such as a hypervisor. VMs provide several advantages over the installation of operating systems and software directly on physical hardware. For example, VMs can be easily moved, copied and reassigned between host servers to optimize resource utilization. Also, isolation between VMs ensures that applications and services that run within a VM cannot interfere with the host operating system or other VMs running on the same host operating system.

Generally stated, the embodiments of the present invention allow for creating an IPv6 packet to carry the payload of the IPv4 packet. The addresses in the header of the IPv6 packet are created by performing a reversible mapping of an IPv4 address into an IPv6 address. Such a mapping would allow, for example, an originating virtual VM and a destination virtual machine VM of the same data center tenant that use IPv4 to communicate with each other over an IPv6 network, deployed in the data center. Typically this conversion is performed by a hypervisor in a node running virtual machines, but may also be performed by any other node at the IPv4-IPv6 boundary.

Such a mapping is reversible so that the hypervisor of the server hosting the destination virtual machine can determine the IPv4 address based on the IPv6 address in the received packet, and thus re-create the IPv4 packet and route it for delivery. Furthermore, such a mapping does not use tunneling. As a result, this method does not need to maintain any session state information. This mapping can be performed in a stateless manner.

This mapping can also provide for isolation of tenants in the data center. The isolation of tenants allows a first tenant to have a Virtual Machine with the same IPv4 address as a Virtual Machine of a second tenant. During the mapping process, the isolation of the tenants can ensure that the two identically addressed machines will not have the same IPv6 address, and thus will not receive data packets addressed to each other.

More specifically, the exemplary embodiments of the present invention introduce a method which generates an IPv6 packet based on an IPv4 packet. For example, the payload of the IPv6 packet is generated based on the payload of the IPv4 packet. The IPv6 packet header is generated to include an IPv6 address which is determined by applying a reversible transformation to a combination of an IPv4 address and an identifier of a tenant.

Because the IPv6 address contains a reversible transformation based on the IPv4 address, it is possible to obtain the IPv4 address back from the IPv6 address at the hypervisor of the server hosting the destination virtual machine. For example, the IPv4 address is obtained by applying the reverse transformation to the reversible transformation contained in the IPv6 address.

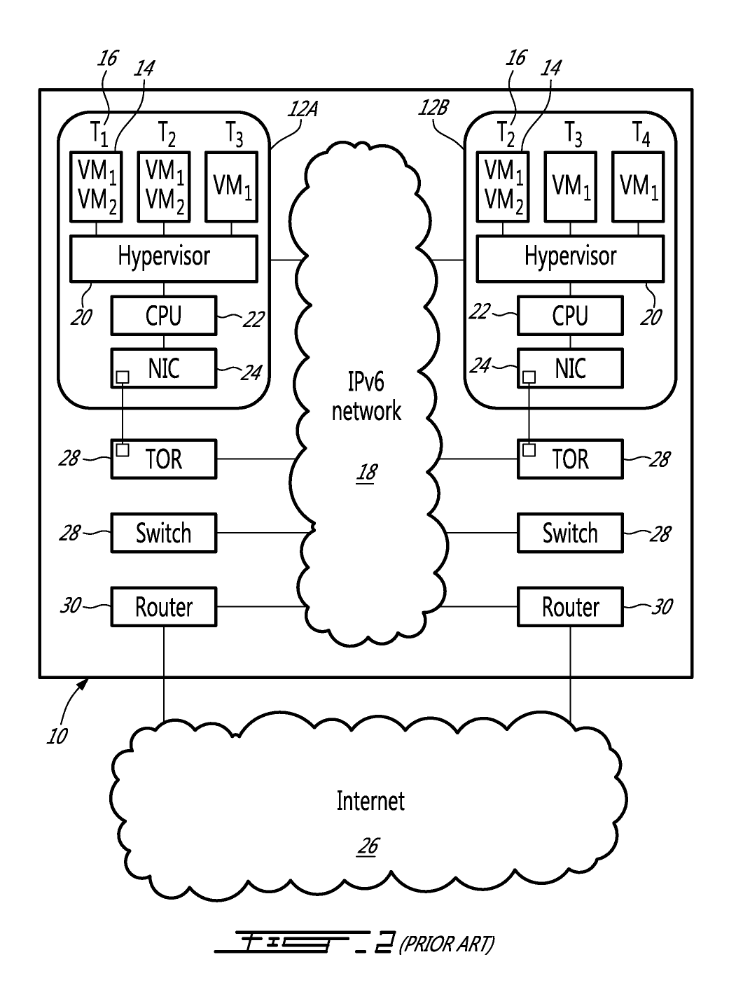

Now, with reference to FIG. 2, the structure of a data center will be described.

The data center 10 of FIG. 2 comprises a plurality of computers or servers 12A, 12B, etc., which will collectively be referred to as servers 12. It should be noted that only two servers 12A and 12B are shown in FIG. 2, this number is purely illustrative. The data center 10 can host a large number of servers 12. Each of the servers 12 can run a plurality of virtual machines (VMs) 14. Many virtual machines 14 still run applications supporting the IPv4 protocol because the IPv4 protocol is still widely used. However, some of the virtual machines 14 could run applications supporting the IPv6 protocol. When in use, a virtual machine 14 is associated with a tenant 16. A tenant 16 can use virtual machines 14 running on different servers 12.

The data center 10 uses an IPv6 network 18 to interconnect the servers 12 and other network nodes, such as switches and routers, within the data center 10. Therefore, the virtual machines 14 on different servers communicate with each other over the IPv6 network 18. When the virtual machines 14 use the IPv4 protocol, a mapping method according to an embodiment of the present invention, is provided, as will described hereinbelow.

The servers 12 have similar infrastructures, therefore, the description of the server infrastructure will be directed to only one server, for example the server 12A.

The server 12A has a hypervisor 20 running thereon. The hypervisor 20 manages the virtual machines 14 running on the server 12A. For example, the hypervisor 20 makes sure that sufficient processing power and resources are allocated to each of the VMs 14, associated with different tenants 16. The hypervisor 20 is further in communication with a Control Processing Unit (CPU) 22, which provides for the processing power and resources of the different VMs 14. The CPU 22 is in connection with a Network Interface Card (NIC) 24.

The NIC 24 allows the server 12A of the data center 10 to be connected to the internet 26, or to any other communication networks, through a plurality of switches 28 and a router 30. The plurality of switches 28 can include a Top of Rack (TOR) switch, a regular switch or any other kinds of switches, such as an OpenFlow switch. The router 30 supports the IPv6 protocol.

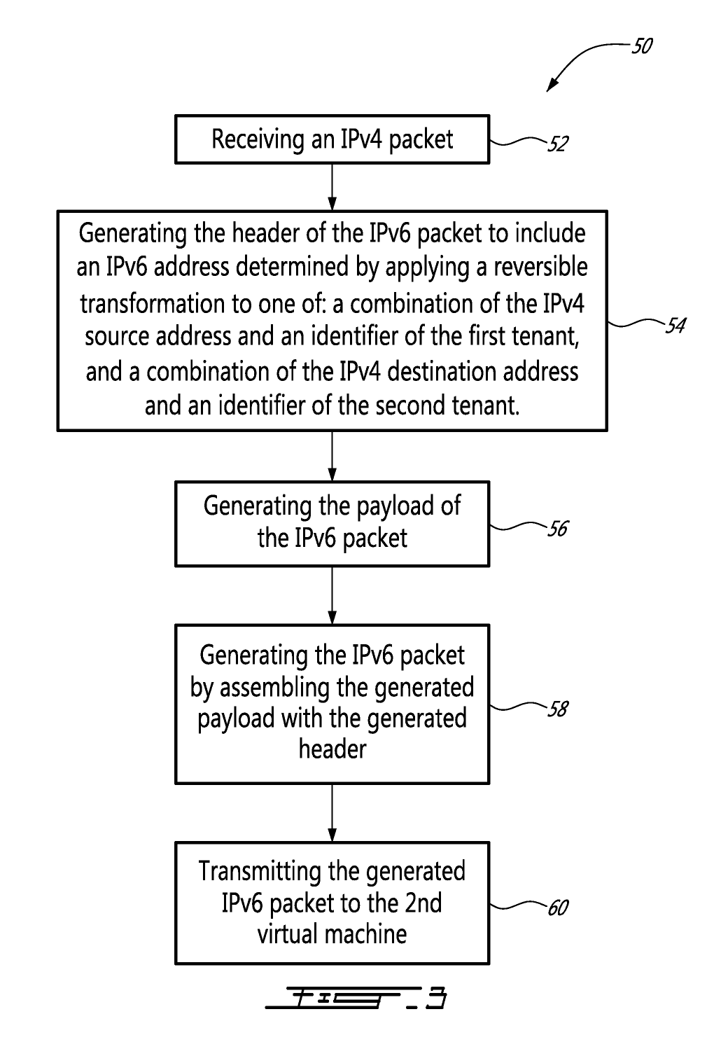

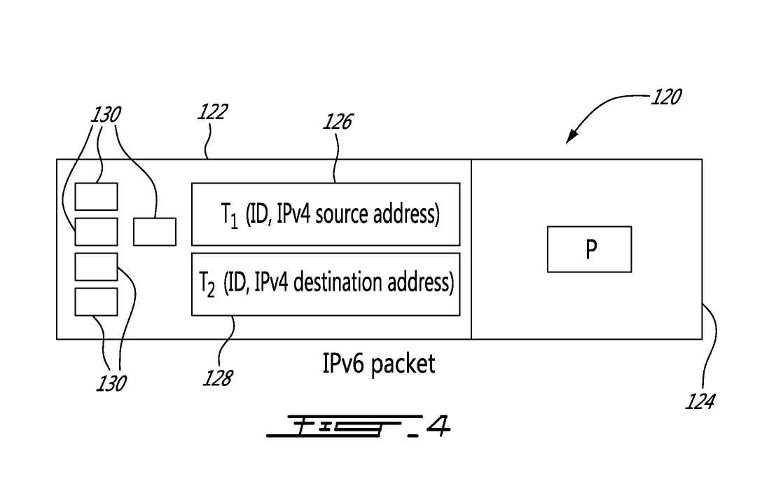

Referring now to FIGS. 3 and 4, a method 50 of routing an IPv4 packet over the IPv6 network 18 as an IPv6 packet, according to an embodiment of the present invention, will be described.

The method 50 of FIG. 3 starts with step 52 in which an IPv4 packet, issued by a first VM (or an originating VM), such as VM1 associated with a first tenant, e.g. T2 (also denoted as VM1/T2), is received. For example, the hypervisor 20 of the server 12A can receive the IPv4 packet. The IPv4 packet is addressed to a second VM (or the destination VM), such as VM2 associated with a second tenant T2 (also denoted as VM2/T2).

Once the IPv4 packet is received, the generation of the IPv6 packet based on the IPv4 packet can start and is performed by the hypervisor 20 on the wire. An example of the generated IPv6 packet 120, having a header 122 and a payload 124, is shown in FIG. 4.

More specifically, the header 122 of the IPv6 packet 120 is generated in step 54. The header 122 is generated to include an IPv6 address, which is determined by applying a reversible transformation to either a combination of the IPv4 source address 106 and an identifier of the first tenant, or a combination of the IPv4 destination address 108 and the identifier of the second tenant. As mentioned earlier, the first tenant is associated with the originating VM and the second tenant is associated with the destination VM.

It should be noted that when the IPv6 address is determined by applying a first reversible transformation to the combination of the IPv4 source address 106 and the identifier of the first tenant, the determined IPv6 address is the IPv6 source address 126. When the IPv6 address is determined by applying a second reversible transformation to the combination of the IPv4 destination address 108 and the identifier of the second tenant, the determined IPv6 address is then the IPv6 destination address 128. In step 54, only one of the IPv6 addresses (source or destination) can be determined or both of the IPv6 addresses can be determined depending on the first and second tenants. For example, if the first and second tenants are one and the same, then both of the IPv6 source and destination addresses will be determined. If the first tenant is different than the second tenant, then, in a first step, the IPv6 source address will be determined by the hypervisor 20. The determination of the IPv6 destination address will be done in a second step, in another network node, such as a router. However, if the hypervisor 20 supports the VMs from both the first and second tenants, then, the hypervisor 20 can determine both the IPv6 source address and the IPv6 destination address.

In step 56, the payload 124 of the IPv6 packet is generated based on the payload 104 of the received IPv4 packet. As an example, the payload 104 of the IPv4 packet can be inserted in the payload field 124 of the IPv6 packet.

In step 58, the IPv6 packet 120 is generated by assembling the payload 124 as generated in step 56 and the header 122 as generated in step 54.

Referring to FIG. 4, the IPv6 packet 120 as generated in steps 54 to 58 is as follows:

the payload 124 contains the payload 104 of the IPv4 packet; and

the header 122 comprises the IPv6 source address 126, which includes a first reversible transformation (T₁) of the combination of the IPv4 source address 106 and the identifier of the first tenant associated with the first virtual machine, and/or the IPv6 destination address 128 which includes a second reversible transformation (T₂) of the combination of the IPv4 destination address 126 and the identifier of the second tenant associated with the second virtual machine.

It should be noted that the order of the steps 54 and 56 described above is arbitrary. For example, step 54 can be performed before, after or in parallel with step 56, without changing the general results of the IPv6 packet generation based on the IPv4 packet.

Once the IPv6 packet 120 is generated, it is transmitted over the IPv6 network 18 to the second virtual machine by the hypervisor 20, in step 60.

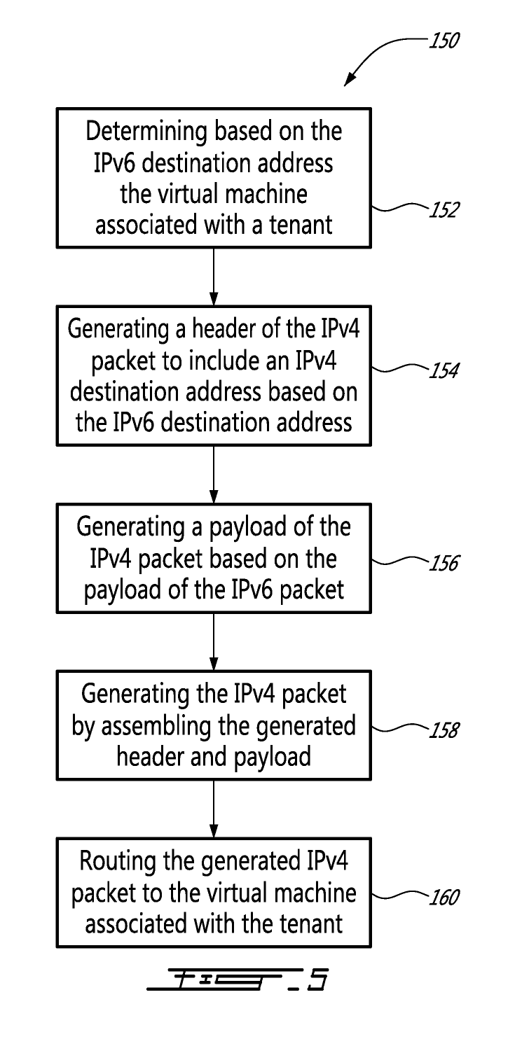

FIG. 5 illustrates a method 150 of delivering an IPv4 packet to a VM (such as VM2/T2) as an IPv6 packet, according to an embodiment of the present invention. For example, the IPv6 packet can be generated as described in method 50. In this case, method 150 allows for regenerating the IPv4 packet from the IPv6 packet, received from the IPv6 network 18. Method 150 can be performed by the hypervisor 20 of the server 12B.

More specifically, method 150 starts with step 152 in which the virtual machine associated with a tenant is determined based on the IPv6 destination address of the received IPv6 packet.

In step 154, the header 102 of the IPv4 packet is generated to include an IPv4 destination address determined based on the IPv6 destination address. For example, the IPv4 destination address is determined by applying the reverse transformation to the IPv6 destination address, which contains the reversible transformation. The IPv4 destination address is then inserted in the field 108 of the header of the IPv4 packet.

In step 156, the payload 104 of the IPv4 packet is generated based on the payload of the IPv6 packet. For example, the IPv4 packet payload is extracted from the IPv6 packet payload.

In step 158, the IPv4 packet 100 is generated by assembling the header 102 as generated in step 154 and the payload 104 as generated in step 156.

It should be noted that the order of the steps 152 to 156 described above is arbitrary. For example, step 154 can be performed before, after or in parallel with step 156, without changing the general results of the IPv4 packet generation based on the IPv6 packet. In the same manner, step 152 can be performed before, after or in parallel with steps 154 and 156.

Once the IPv4 packet 100 is generated, in step 160, the hypervisor 20 routes the IPv4 packet 100 to the virtual machine VM2/T2, as determined in step 152.

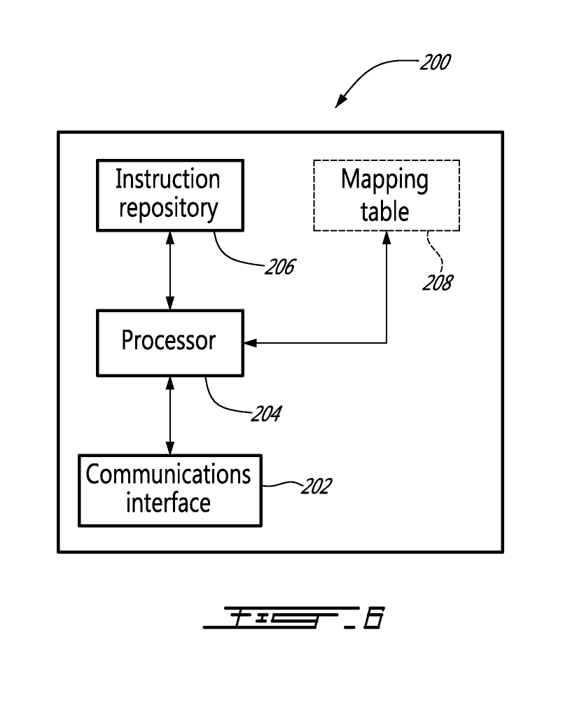

FIG. 6 illustrates a network node 200 for routing or delivering an IPv4 packet according to an embodiment of the present invention. The network node 200 could be exemplified by the server 12, the router 30 or any switches 28 in the data center 10.

The network node 200 comprises a communication interface 202, a processor 204 operationally connected to the communication interface 202, an instruction repository 206 operationally connected to the processor 204, and optionally a mapping table 208 of tenant identifiers. The network node 200 can be configured either to carry out method 50, method 150 or a combination thereof.

The network node 200 can further comprise additional processors, memories and other components for performing tasks and procedures of the present invention and other asks and procedures as is well-known in the art.

When the network node 200 is configured to carry out method 50, the communication interface 202 is used to receive the IPv4 packet 100 from the first virtual machine 14 and to send out the IPv6 packet 120 to the IPv6 network 18. The IPv6 packet is generated based on the received IPv4 packet and is addressed to the second virtual machine.

The instruction repository 206 stores instructions that when executed cause the processor 204 to generate the IPv6 packet 120 based on the received IPv4 packet 100 according to the method 50.

More specifically, the processor 204 generates the header 122 of the IPv6 packet 120 to include an IPv6 address determined based on the IPv4 address and an identifier of a tenant. For example, to determine the IPv6 source address, the processor 204 applies a first reversible transformation to the combination of the IPv4 source address 106 and the identifier of the first tenant associated with the first VM. To determine the IPv6 destination address, the processor 204 applies a second reversible transformation to the combination of the IPv4 destination address 108 and the identifier of the second tenant associated with the second VM. The processor 204 may use the mapping table 208 to obtain the identifiers corresponding to the first and second tenants.

The processor 204 further generates the payload 124 of the IPv6 packet based on the payload 104 of the received IPv4 packet. Then, the processor 204 assembles the payload generated for the IPv6 packet with the header generated for the IPv6 packet to form the IPv6 packet 120.

The sequence of the different operations performed by the processor 204 is arbitrary. Other sequences can be used, as will be appreciated by a person skilled in the art.

When the network node 200 is configured to carry out method 150, the communication interface 202 is used to receive the IPv6 packet 120 from the IPv6 network 18 and to transmit the IPv4 packet 100, generated based on the received IPv6 packet, to the destination virtual machine.

The instruction repository 216 stores instructions that when executed cause the processor 204 to determine the virtual machine associated with a tenant based on the IPv6 destination address and to generate the IPv4 packet based on the received IPv6 packet, according to method 150.

More specifically, the processor 204 generates the header 102 of the IPv4 packet to include an IPv4 destination address determined based on the IPv6 destination address. The processor 204 further generates the payload 104 of the IPv4 packet from the payload 124 of the received IPv6 packet. Then, the processor 204 assembles the payload generated for the IPv4 packet with the header generated for the IPv4 packet to form the IPv4 packet 100. The processor 204 also determines the VM associated with the tenant based on the IPv6 destination address of the received IPv6 packet.

The order of the different operations performed by the processor 204 is arbitrary. Other orders can be used as will be appreciated by skilled persons in the art.

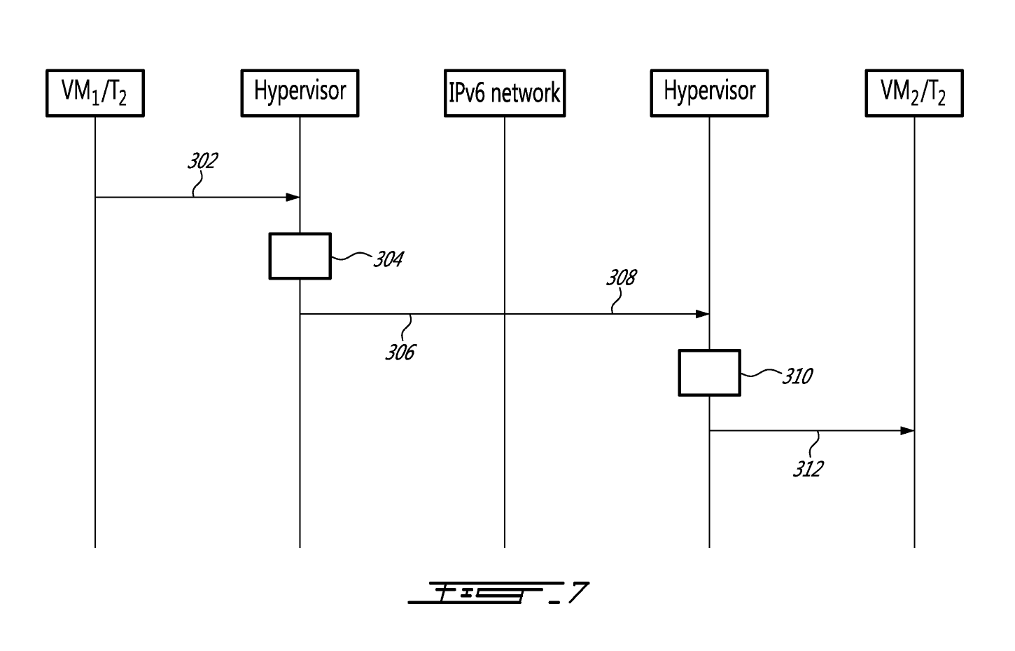

Now, with reference to FIG. 7, a flow diagram of an exemplary implementation of a communication between a first virtual machine and a second virtual machine over the IPv6 network 18, according to an embodiment of the present invention, will be described.

For example, the first virtual machine has an IPv4 address. The first virtual machine is instantiated on the server 12A that has an IPv6 address and is connected to the IPv6 network 18. Also a second server (12B) is connected to the IPv6 network 18; the second server provides an instantiation of the second virtual machine which has an IPv4 address. When the first virtual machine, e.g. VM1 associated with tenant T2 (VM1/T2), wants to send a packet to the second virtual machine, e.g. VM2 associated with tenant T2 (VM2/T2), it creates an IPv4 packet having a source address corresponding to its own IPv4 address, and a destination address corresponding to the IPv4 address of the second virtual machine.

Then, in step 302, VM1/T2 sends the IPv4 packet to the hypervisor 20 provided by the first server 12A, the IPv4 packet being addressed to VM2/T2.

After reception of the IPv4 packet, the hypervisor 20, which effectively sits at the IPv4/IPv6 boundary, performs an IPv4-to-IPv6 translation, among other services. More specifically, it generates an IPv6 packet 120 based on the received IPv4 packet (step 304) on the wire, in accordance with steps 52 to 58 of method 50.

Also, it should be noted that the data center in which the servers 12A and 12B reside has an assigned chunk of IPv6 addresses. The chunk of IPv6 addresses is distributed among the plurality of tenants and other entities in the data center. Thus, each tenant in the data center is provided with a block of IPv6 addresses. For the sake of a simplified discussion, the block of address assigned to each tenant will be assumed to be a contiguous block. If each tenant is provided a 32-bit address space of IPv6 addresses, the first 96 bits of the IPv6 address will be identical across each VM associated with the same tenant (regardless of which server the VM is instantiated on), according to an embodiment of the invention. This 96 bit block, which will be referred to as a prefix, can be used as a tenant identifier, as will be described in more detail hereinbelow.

According to an embodiment of the present invention, in order to generate an IPv6 address based on an IPv4 address, a reversible transformation or function is applied to the IPv4 address. A simple example of such a reversible transformation could be a function that concatenates a prefix and an IPv4 address to form the IPv6 address, the prefix corresponding to an identifier of the tenant. This concatenation of the prefix and the IPv4 address is reversible, i.e. it can be undone at the receiving end. Each tenant is assigned a unique prefix which uniquely identifies that tenant. The hypervisor 20 can use a mapping table, such as the mapping table 208 of FIG. 6 to map a tenant to the prefix which has been assigned thereto. The mapping table can be as follows:

TABLE 1
Prefix mapping table

| Virtual Machines | Tenant | Prefix |
|---|---|---|
| VM1 | T1 | P1 |
| VM2 | T1 | P1 |
| VM1 | T2 | P2 |
| VM2 | T2 | P2 |
| VM3 | T3 | P3 |
| VM4 | T4 | P4 |

The first column of Table 1 indicates the different VMs 14, the second column indicates the tenants associated with the different VMs and finally the third column indicates the prefix assigned to the tenants.

More particularly, in step 304, the generation of the IPv6 packet is as follows. After the hypervisor 20 receives the IPv4 packet, it looks up the mapping table 208 to determine the prefix corresponding to the tenant associated with the first VM. In this example, it determines that the prefix is P2, which has been assigned to tenant T2. It also extracts the IPv4 source address and the IPv4 destination address from the header of the received IPv4 packet.

Then, it creates the IPv6 source address by concatenating the prefix P2 with the extracted IPv4 source address. The created IPv6 source address is [P2|IPv4 source address]. In the same manner, the IPv6 destination address is created to be [P2|IPv4 destination address].

It should be noted that the prefix, such as P2, is 96 bit long and any of the IPv4 addresses is 32 bit long. By concatenating the prefix with the IPv4 address, an address of 128 bits is obtained, which corresponds to the size of an IPv6 address. Also, it should be noted that the tenant identifier and the IPv4 address, taken in combination, will uniquely identify a VM to which the IPv4 packet is to be delivered.

It has been assumed that the address block assigned to each tenant is contiguous. However, where the address block assigned to each tenant is non-contiguous, it can still be arranged so that there are 96 bits which are the same for each VM associated with the same tenant. This would result in an interleaved tenant identifier.

Also, it should be understood that, in a preferred embodiment of the present invention, the tenant identifier is a prefix. However, in other embodiments the tenant identifier can be a suffix or can be interleaved with other address bits so that it is non-contiguous. There may be implementation specific advantages to having the tenant identifier used as a prefix in that the concatenation of two values is a rather simple processing task, and that having the identifier as a prefix allows for a smaller block of IPv6 addresses to be needed.

It will be appreciated by those skilled in the art that any other transformation or function is possible, for address conversions, as long as the transformation is reversible.

Regarding the generation of the IPv6 packet payload, the hypervisor 20 simply inserts the IPv4 packet payload into the IPv6 packet payload. The payload of the IPv6 payload may include other data.

Remaining fields in the IPv6 header can be either generated in accordance with values in the IPv4 header or can be generated by conventional means. The resulting IPv6 header should contain valid data to prevent it from being dropped by other nodes.

The generated IPv6 packet is transmitted over the IPv6 network 18, in step 306.

In step 308, the hypervisor 20 of the server 12B hosting VM2 associated with tenant T2 receives the IPv6 packet.

In step 310, the hypervisor 20 extracts the prefix from the IPv6 destination address, looks the extracted prefix up in the mapping table 208 to determine the tenant corresponding to the prefix, and determines the virtual machine associated with the identified tenant. The determination of the tenant fixes 96 bits of the 128 bit IPv6 address. The remaining 32 bits of the IPv6 address can be determined in accordance with the 32 bit IPv4 address. More specifically, the hypervisor 20 extracts the IPv4 destination address from the IPv6 destination address and the IPv4 source address from the IPv6 source address. The extracted IPv4 source and destination addresses are then included in the header of the IPv4 packet. The hypervisor 20 further extracts the payload of the IPv4 packet from the payload of the IPv6 packet. Then, the hypervisor 20 assembles the extracted payload with the header of the IPv4 packet, which includes the extracted IPv4 source and destination addresses. Once the IPv4 packet is assembled (or generated), the hypervisor 20 routes it to VM2/T2.

The above example has been described for routing and delivering IPv4 packets between two virtual machines associated with the same tenant.

It is also possible that VMs from different tenants communicate with each other. For example, suppose that VM1 associated with tenant T1 initiates a communication session with VM1 associated with tenant T2. In this case, when the hypervisor 20 of the server hosting VM1 associated with tenant T1 receives the IPv4 packet, it generates an IPv6 packet having an IPv6 source address as generated in step 304 by concatenating the prefix corresponding to tenant T1 with the IPv4 source address. However, for the IPv6 destination address, it will indicate the address of the router 30, which is an IPv6 address. Once the router 30 receives the IPv6 packet, it generates a new IPv6 destination address, based on the IPv4 destination address. It generates the IPv6 destination address by concatenating the prefix assigned to tenant T2 with the IPv4 destination address.

It should be noted that, using such a transformation, when a same IPv4 address is assigned to virtual machines associated with different tenants, the generated IPv6 address based on the IPv4 address is different for each of the virtual machines, because of the unique prefix assigned to each of the tenants.

As mentioned above, embodiments of the present invention allow data centers to deploy an IPv6 network while supporting legacy IPv4 applications running in the virtual machines. They provide for simple Networking Address Management while supporting IPv4 and IPv6 applications. They are also transparent to the virtual machines and to the applications running on the virtual machines.

It should be appreciated that in the preceding discussion, terms such as “first”, “second”, and the like, are used to distinguish various elements from one another and are not intended to imply a particular order or priority, unless the context clearly indicates otherwise. Like terms refer to like elements throughout the description. Likewise, as used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise. When a process is illustrated or claimed herein, it should be understood that the steps or operations of that process may be performed in any order unless the context clearly requires otherwise.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method, for use in a data center having tenants, of routing an Internet Protocol version 4 (IPv4) packet, having a payload and a header that includes IPv4 source and destination addresses, over an Internet Protocol version 6 (IPv6) network as an IPv6 packet having a payload and a header, the method comprising:
receiving the IPv4 packet from a first virtual machine associated with a first tenant, the IPv4 packet addressed to a second virtual machine associated with a second tenant;
generating the header of the IPv6 packet to include an IPv6 address determined by applying a reversible transformation to one of:
a combination of the IPv4 source address and an identifier of the first tenant, and
a combination of the IPv4 destination address and an identifier of the second tenant;
generating the payload of the IPv6 packet based on the payload of the received IPv4 packet;
generating the IPv6 packet by assembling the generated payload of the IPv6 packet with the generated header of the IPv6 packet; and
transmitting the generated IPv6 packet over the IPv6 network to the second virtual machine.

2. The method of claim 1, wherein the step of generating the header of the IPv6 packet to include an IPv6 address further includes determining an IPv6 source address by applying the reversible transformation to the combination of the IPv4 source address and the identifier of the first tenant.

3. The method of claim 1, wherein the step of generating the header of the IPv6 packet to include an IPv6 address further includes determining an IPv6 destination address by applying the reversible transformation to the combination of the IPv4 destination address and the identifier of the second tenant.

4. The method of claim 1, wherein the step of generating the header of the IPv6 packet to include an IPv6 address further includes:
determining an IPv6 source address by applying a first reversible transformation to the combination of the IPv4 source address and the identifier of the first tenant: and
determining an IPv6 destination address by applying a second reversible transformation to the combination of the IPv4 destination address and the identifier of the second tenant.

5. The method of claim 4, wherein the step of determining the IPv6 source address and the IPv6 destination address further includes mapping the identifier of the first tenant to a first prefix and the identifier of the second tenant to a second prefix.

6. The method of claim 1, wherein the first tenant and the second tenant are one and the same.

7. The method of claim 5, wherein the steps of determining the IPv6 source address further includes concatenating the first prefix with the IPv4 source address and determining the IPv6 destination address further includes concatenating the second prefix with the IPv4 destination address.

8. The method of claim 1, wherein the step of generating the payload of the IPv6 packet further includes inserting the payload of the received IPv4 packet into the payload of the IPv6 packet.

9. A method, for use in a data center having tenants, of delivering an Internet Protocol version 4 (IPv4) packet to a virtual machine, the IPv4 packet being received as an IPv6 packet having a payload and a header which includes an IPv6 destination address, the method comprising:
determining the virtual machine associated with a tenant based on the IPv6 destination address;
generating a header of the IPv4 packet to include an IPv4 destination address determined based on the IPv6 destination address;
generating a payload of the IPv4 packet based on the payload of the IPv6 packet;
generating the IPv4 packet by assembling the generated header with the generated payload; and
routing the generated IPv4 packet to the determined virtual machine associated with the tenant.

10. The method of claim 9, wherein the step of determining the virtual machine associated with a tenant further includes extracting a prefix from the IPv6 destination address, the prefix being assigned to the tenant.

11. The method of claim 9, wherein the step of generating the header of the IPv4 packet to include the IPv4 destination address further includes extracting the IPv4 destination address from the IPv6 destination address.

12. The method of claim 9, wherein the step of generating the payload of the IPv4 packet further includes extracting the payload of the IPv4 packet from the payload of the IPv6 packet.

13. A network node, in a data center having tenants, for routing an Internet Protocol version 4 (IPv4) packet, having a payload and a header that includes IPv4 source and destination addresses, over an Internet Protocol version 6 (IPv6) network as an IPv6 packet having a payload and a header, the network node comprising:
a communication interface for receiving the IPv4 packet from a first virtual machine associated with a first tenant, the IPv4 packet addressed to a second virtual machine associated with a second tenant; and
a processor operationally connected to the communication interface and configured to:
generate the header of the IPv6 packet to include an IPv6 address determined by applying a reversible transformation to one of:
a combination of the IPv4 source address and an identifier of the first tenant, and
a combination of the IPv4 destination address and an identifier of the second tenant;
generate the payload of the IPv6 packet based on the payload of the received IPv4 packet; and
generate the IPv6 packet by assembling the generated payload of the IPv6 packet with the generated header of the IPv6 packet;
wherein the communication interface further transmits the generated IPv6 packet over the IPv6 network to the second virtual machine.

14. The network node of claim 13, wherein the processor further determines an IPv6 source address by applying a first reversible transformation to the combination of the IPv4 source address and the identifier of the first tenant, and an IPv6 destination address by applying a second reversible transformation to the combination of the IPv4 destination address and the identifier of the second tenant.

15. The network node of claim 14, wherein the processor further maps the identifier of the first tenant to a first prefix and the identifier of the second tenant to a second prefix.

16. The network node of claim 15, wherein the processor further determines the IPv6 source address by concatenating the first prefix with the IPv4 source address and determines the IPv6 destination address by concatenating the second prefix with the IPv4 destination address.

17. The network node of claim 13, wherein the processor further inserts the payload of the IPv4 packet into the payload of the IPv6 packet.

18. A network node, in a data center having tenants, for delivering an Internet Protocol version 4 (IPv4) packet to a virtual machine, the IPv4 packet being received as an IPv6 packet having a payload and a header which includes an IPv6 destination address, the network node comprising:
a processor configured to:
determine the virtual machine associated with a tenant based on the IPv6 destination address;
generate a header of the IPv4 packet to include an IPv4 destination address determined based on the IPv6 destination address;
generate a payload of the IPv4 packet based on the payload of the IPv6 packet; and
generate the IPv4 packet by assembling the generated header with the generated payload; and
a communication interface in connection with the processor for routing the generated IPv4 packet to the virtual machine associated with the tenant.

19. The network node of claim 18, wherein the processor further extracts a prefix from the IPv6 destination address, the prefix being assigned to the tenant.

20. The network node of claim 18, wherein the processor further extracts the IPv4 destination address from the IPv6 destination address.

21. The network of claim 18, wherein the processor further extracts the payload of the IPv4 packet from the payload of the IPv6 packet.
